(19) United States
(12) Patent Application Publication
(10) Pub. No.: US 2014/0136399 A1
(43) Pub. Date: May 15, 2014

(54) METHOD FOR ESTABLISHING USER CONNECTIONS AND A COMPUTER NETWORK SYSTEM EMPLOYING SAME

(71) Applicant: BIXnets Inc., Calgary (CA)

(72) Inventor: Brad GAULIN, Calgary (CA)

(73) Assignee: BIXnets Inc., Calgary (CA)

(21) Appl. No.: 14/078,103

(22) Filed: Nov. 12, 2013

Related U.S. Application Data
(60) Provisional application No. 61/725,355, filed on Nov. 12, 2012.

(51) Int. Cl. G06Q 20/26; G06Q 50/00; H04L 12/58

(52) U.S. Cl. CPC G06Q 20/26; H04L 51/32; G06Q 50/01
USPC 705/39

(57) ABSTRACT

A method and a computer network system for establishing fee-based contacts between users are disclosed. The system sets up a system credit account, and sets up a user credit account for each user thereof. Each user may designate a fee for establishing a contact therewith. A first user may add a second user to the contact list by paying a basic fee set up by the system and the fee designated by the second user. At least a portion of the fee paid by the first user is deposited to the system credit account and the rest is deposited to the credit account of the second user.

### CROSS-REFERENCE TO RELATED APPLICATIONS

This application claims the benefit of U.S. Provisional Application No. 61/725,355, filed Nov. 12, 2012, which is incorporated herein by reference in its entirety.

### FIELD OF THE DISCLOSURE

The present disclosure generally relates to a method and a computer network system for establishing user contacts, and in particular, relates to a method and a social network system for establishing fee-based contacts between users.

### BACKGROUND OF THE DISCLOSURE

Social networks, such as Facebook®, LinkedIn®, Google+™, Myspace® and the like, are known. Typically in these social networks, a first user may allow other users to freely establish a contact thereto. A second user thus may find the first user (e.g., by searching or by browsing a user list), and add the first user to his contact list.

Alternatively, a contact may only be established under explicit allowance. In this case, a second user has to send a contact request to a first user, and wait until the first user accepts the contact request before the second user could add the first user to the contact list.

Typically, after the second user adds the first user to his contact list, the second user is automatically added to the first user's contact list. After the first and second users are mutually added to each other's contact list, a connection between them may be established at anytime they wish.

In these social network systems, adding users to one's contact list and establishing connections thereto are usually free of charge. Neither any user nor the service providers of these systems earn any profit therefrom. Monetizing a social network is generally difficult and hitherto heavily relies on advertisement revenue.

The greatest asset in business is people, and their invaluable know-how. Currently, there is a looming talent crisis facing business as baby boomers leave and the next generations replace them. A 2008 US Congressional report states 42% of the 2008 workforce are boomers that are expected to retire in the next 10 years and this is repeated in studies all over the world. Next-gen professionals replacing the boomers don't have the same know-how, or talents, they work and behave differently, and are much more mobile than their predecessors. Considering these factors, transferring and retaining knowledge is a primary concern in most enterprises. The challenge is finding an effective solution that works for everyone. Most organizations believe the transferring of know-how between generations is best done through mentoring, but mentoring the old way isn't working. Therefore, there is a desire of monetizing a social network, and facilitating users and service providers of a social network to earn profit therefrom.

### SUMMARY OF THE DISCLOSURE

According to one aspect of this disclosure, there is provided a system and method for providing a social network platform for users to profit from being connected with other users.

According to another aspect of this disclosure, a user has to pay a fee for adding another user to a contact list thereof.

According to yet another aspect of this disclosure, the fee comprises a basic fee payable to the service provider of the system, and a DC fee designated by the user to be added to a contact list.

According a still another aspect of this disclosure, the DC fee is split between the system and the user payable thereto in accordance with a ratio agreed between the system and the user.

According to another aspect of this disclosure, a first user may establish a private connection to a second user via their client computing devices after the first user adds the second user to a contact list thereof.

According to another aspect of this disclosure, there is provided a method for establishing a conversation connection between a first and a second client computing devices via a computer network, said method comprising:

setting up a system credit account;

registering the user of the first client computing device in the computer network, said registering comprising registering a first credit account for the user of the first client computing device;

registering the user of the second client computing device in the computer network, said registering comprising registering a second credit account for the user of the second client computing device;

in response to a first command from the user of the first client computing device, transferring a request for establishing contact from the user of the first client computing device to the user of the second client computing device,

in response to a second command of the user of the second client computing device, establishing a contact between the user of the first client computing device and the user of the second client computing device; and in response to a third command from any one of the user of the first client computing device and the user of the second client computing device, establishing a conversation connection between the first and second client computing devices; wherein said establishing a contact further comprises:

transferring a total amount of credits out of the first credit account;

depositing at least a portion of the total amount of credits into the system credit account; and

depositing the rest of the total amount of credits into the second credit account.

According to another aspect of this disclosure, the system further provides a platform for users to profit from providing services to other users, and establishes a multiple-level fee structure for a user to profit from being connected with other users and from providing professional services thereto. The fee charged to users enjoying the provided professional services may be split between the user who provides the professional services and the system in accordance with a ratio agreed therebetween.

According to another aspect of this disclosure, the system disclosed herein provides a solution for corporate knowledge management where everyone, including retirees, can share, mentor and prosper.

According to another aspect of this disclosure, the system disclosed herein is a self-managed, mentoring social network that recognizes and rewards people for sharing expertise. It is a cloud platform that gives companies a new way to transfer and retain knowledge using value-added content to drive a mentor social network, and user recognition and financial reward to make it engaging so “everyone” contributes and benefits. The system provides a capture-mentor-reward model for users to share content and resources (e.g., YouTube™ videos, slideshare or the like), mentor others through the system, and obtain payment for sharing know-how & mentoring.

Every business has a training & development budget for each employee. Most company's first choice is to mentor from within. According to another aspect, this disclosure disclosed a system through which employee's contributions are recognized and rewarded, know-how is retained and transferred within the organization, succession risk is reduced at various levels, and an invaluable intellectual-capital asset is built. When employees leave with their know-how, companies can still engage them from the system.

According to another aspect of this disclosure, the system disclosed herein is designed to enable companies to retain and transfer their internal knowledge, while also giving them access to retiree's expertise after they leave the organization. It provides a platform supporting knowledge transfer both inside and outside the organization, and uses content to drive the mentoring social network, with a recognition and reward system that values every knowledge exchange/transaction.

According to another aspect of this disclosure, the system disclosed herein provides multiple-level revenue streams, for example, a Private Enterprise Platform with a price of about $5 to $10 per user per month Platform as a service (PaaS) Licensing, an Open Retiree Platform with 25% Content/resource sales commission, an Open Retiree Platform with 10% Mentor time sales commission, an Open Retiree Platform with a price of $1 per connection plus 25% of user-set Social network fee, and an Open Retiree Platform with targeted ad placements and listing fees.

According to another aspect of this disclosure, the system disclosed herein allows users of the system to be recognized and rewarded for packaging and sharing their innovations, best practices, successes, failures, experiences, know-how, and for mentoring others to solve problems, develop skills and succeed. An organization deploying the system can benefit from the system for capturing and retaining high value intellectual-capital as a strategic asset, reducing succession risk at all levels throughout the organization, driving more engagement & retention with next-gen staff, retaining retiree know-how and engagement, faster time to competency and productivity for new staff, and better Return on investment (ROI) on professional development spending. Individuals using the system can benefit from the system for being recognized and rewarded for sharing knowledge, providing know-how that empowers others to “do-it-themselves”, and mentoring more people to grow and succeed with less time and effort. As a cloud platform, the system disclosed herein is a simple, high gain, low risk, low pain solution.

According to another aspect, this disclosure discloses a system through which a user's expertise can be shared with next-generation professionals, the value of the user's “know-how” is retained, recognized and rewarded and the user is building a legacy by empowering others. Users can keep themselves as engaged and active, turn their expertise into income, connect with next-generation professionals, retain their intellectual property rights, and expand their legacy by mentoring more people, in less time, with less effort—on their terms.

According to another aspect of this disclosure, the system disclosed herein makes it easy for users to package their processes, innovations, best practices, experiences, and know-how; share and promote it, advise and mentor others to succeed using it.

According to another aspect of this disclosure, the system disclosed herein is a social network system where networking is driven by a mentor Marketplace™ where users can easily package and share their know-how as content, use that content to make connections, build networks, develop relationships, mentor others to succeed, and be recognized and rewarded for the value of every knowledge exchange/transaction. The system provides functionalities for associating with other social networks such as LinkedIn®, Facebook®, Twitter® and Google+™. What the users need to do includes uploading, i.e., sharing content/resources that have the most value, e.g., solutions; the higher the value, the better the user's ratings, the more it showcases and differentiates the user's expertise; promoting, i.e., promoting user's resources stored in the system with one click to other social networks, e.g., LinkedIn®, Facebook®, Twitter® and Google+™; networking, i.e., adding people who download the user's resources into the user's network, and mentoring, i.e., developing on-line relationships by advising and ultimately mentoring others to solve problems, developing skills and succeeding, faster, better, as the user like.

According to another aspect of this disclosure, the system disclosed herein is a cloud based system, i.e., a system being a Platform as a service (PaaS) or Software as a service (SaaS), which does not require users to install any client software program.

### BRIEF DESCRIPTION OF THE DRAWINGS

FIG. 1 illustrates a high-level hardware structure of a computer network system for establishing connections between users according to one embodiment;

FIG. 2 illustrates a software structure of the computer network system of FIG. 1;

FIG. 3 illustrates a structure of a user profile;

FIG. 4 is a flowchart illustrating a process for a user to establish connections to other users;

FIG. 5 is a flowchart illustrating the detail of the step of setting up a user profile in FIG. 4;

FIG. 6 shows a portion of an example Graphic User Interface (GUI) that a user may use to set up his user profile;

FIG. 7 is a flowchart illustrating the detail of the step of establishing a Direct Connect (DC) contact with another user in FIG. 4;

FIG. 8 shows a portion of an example GUI displaying User_B's public profile;

FIG. 9 illustrates a portion of an example GUI listing DC invitations that a user has sent, and DC invitations that the user has received;

FIG. 10 shows an example of the detail of step of user interaction and review in FIG. 4;

FIG. 11 shows an example of a GUI for browsing contact lists;

FIG. 12 illustrates a process for a user to purchase service time from another user, according to an alternative embodiment;

FIG. 13 shows an example of the purchase request form GUI in according to the embodiment of FIG. 12;

FIG. 14 shows an example of the mentor response form GUI in according to the embodiment of FIG. 12;

FIG. 15 shows an example of the user approval form GUI in according to the embodiment of FIG. 12; and

FIG. 16 illustrates the detail of the completing transaction step 574 in FIG. 12.

### DETAILED DESCRIPTION

The system described herein allows a user to become a Direct Connect (DC) contact of another user, i.e., to add the other user to a DC contact list thereof, by paying a basic fee charged by the system and a DC fee designated by the other user. In some embodiments described below, a user may become a DC contact of a mentor who can provide limited support, advice or deliverables. The DC contact may result in a business relationship outside the system. Such an embodiment is one form of the present disclosure and one implemented in applicant's GOmentr.com website, offered by BIXnets Inc. of Calgary, Alberta, Canada, that provides a mentor Marketplace™ knowledge management system for users to establish Mentor Connect™ with mentors and experts, where everyone can easily package and share know-how as content, use that content to build networks, develop mentor relationships, collaborate to succeed, and be recognized and rewarded for the value of every knowledge exchange/transaction (share-mentor-prosper). One aspect of such as system enables a user to choose to designate a Mentor Connect™ fee chargeable to other users for being added to their contact lists.

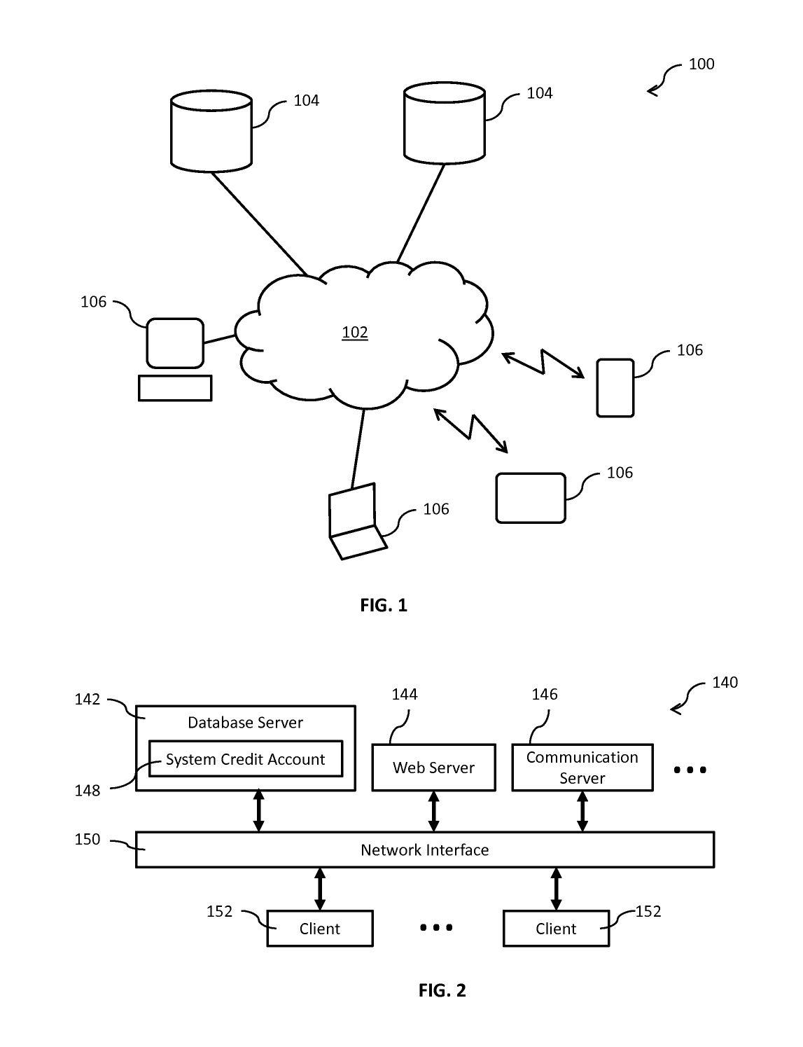

Turning to FIG. 1, in one embodiment of the present disclosure, a computer system 100 is illustrated. The computer system comprises a computer network 102, one or more computer servers 104 functionally connecting to the network 102, and a plurality of client computing devices 106 functionally connecting to the network 102. Here, the computer network 102 is a network for connecting computing devices, and may be a local area network (LAN), wide area network (WAN), metropolitan network (MAN), Internet, or the like. It may also be a wired or wireless communication network for connecting smart phones such as a 4G wireless communication network. As those skilled in the art appreciate, computer servers 104 and client computing devices 106 may connect to the network 102 via wired or wireless means, e.g., Ethernet, WiFi®, Bluetooth®, Zigbee®, or the like.

A computer server 104 may comprise a central processing unit (CPU), a storage such as Read-Only Memory (ROM), volatile and/or non-volatile Random Access Memory (RAM), solid state drive, hard drive, or the like, a network module, and other components, all connected to the CPU via one or more signal buses. Each computer server 104 executes an operating system, e.g., Unix®, Linux®, Microsoft® Window NT, Microsoft® Windows 2000 Server, Microsoft® Windows Server 2012 or the like. Generally, an operating system is a set of computer readable code executed by the CPU for managing various hardware and software components, and for supporting the execution of application programs.

The client computing devices 106 may be tablets, smart-phones, desktop computers, laptop computers and the like. As those skilled in the art appreciate, a client computing device 106 may comprise a CPU, a storage, a network module, an input device for receiving user input, and a display, all connected to the CPU via one or more signal buses. In one embodiment, some client computing devices 106 may comprise a touch sensitive screen for displaying output thereon and receiving user input therefrom. Each client computing device 106 executes an operating system, e.g., Microsoft® Windows®, Apple® Mac OS®, Apple® IOS™, Google Android™, Microsoft® Windows® Mobile, BlackBerry® OS, or the like.

FIG. 2 illustrates a software structure 140 of the computer system 100. As shown, the computer system 100 comprises one or more software servers, such as a database server 142, a web server 144 and a communication server 146, a network interface 150, and a plurality of client programs 152.

The database server 142 comprises one or more databases (not shown) for storing user profiles (described later), a system credit account 148 that records credits owned by the service provider of the system, and other information as required. In this embodiment, the system 100 engages with the PayPal™ system and the system credit account 148 is the PayPal™ credit account of the service provider of the system 100.

The web server 144 provides a web-based interface for client programs 152 to access information stored in the database server 142 and functionalities provided by the servers 142 to 146. The communication server 146 establishes conversation connections (e.g., audio, video, data connections or multimedia connections suitable for transferring at least some of audio, video, data information) between client programs 152 in response to user requests.

The system 100 may also comprise other software servers as needed. As those skilled in the art appreciate, the software servers 142 to 146 may be running on one or more server computers 104, depending on the system design and configuration.

Each client program 152 is running on a client computing device 106. The client programs 152 interact with software servers 142 to 146 via the network interface 150. The client programs 152 may also interact with each other via the network interface 150 with the support and administration of the communication server 146. In some alternative embodiments, at least some software clients 152 may directly interact with each other via the network interface 150, without the support and administration of the communication server 146.

In this embodiment, the client program 152 is a web browser, such as Microsoft® Internet Explorer®, Apple® Safari®, Mozilla® Firefox®, Opera™, or the like, running on client computing devices 106, and executing code, e.g., JavaScript code or an ActiveX program module, downloaded from the web server 142. However, those skilled in the art appreciate that, in some alternative embodiments, some or all client programs 152 may be a standalone program, e.g., a so-called App, running on the client computing devices 106.

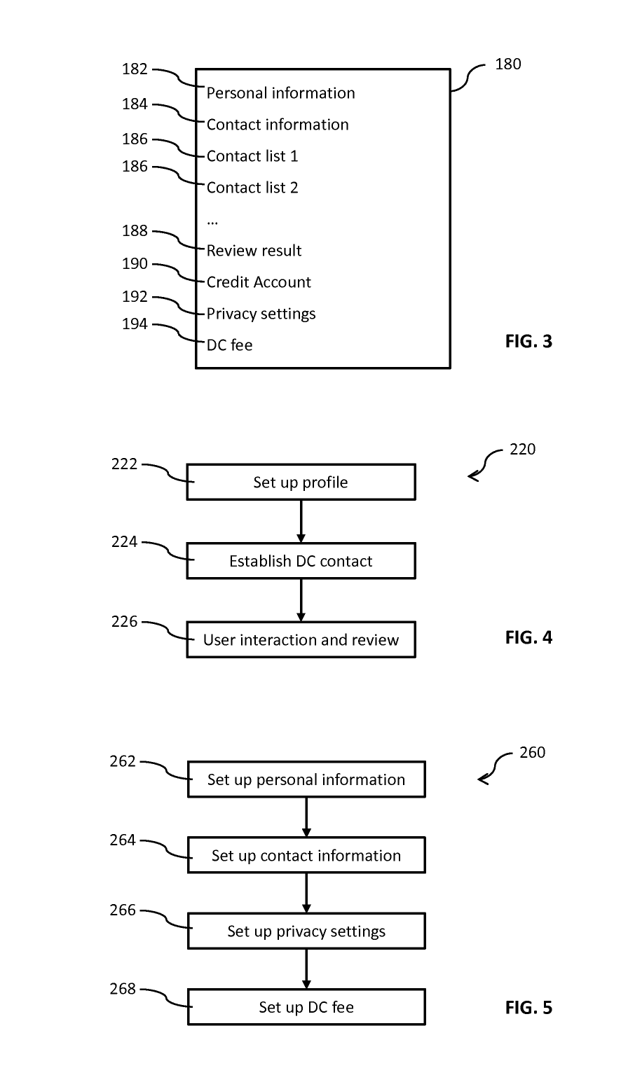

The user of a client computing device 106 may run a client program 152 and connects to servers 142 to 146 to set up a user profile, search other users, adding other users to a contact list, and establish a conversation connection to other users. FIG. 3 shows a structure of a user profile 180. As shown, a user profile 180 comprises personal information 182, the user's contact information 184, such as the user's social network ID, email address, phone numbers or the like, one or more contact lists 186, the user's review result 188 received from other users, the user's credit account 190 indicating the credits that the user owns, privacy settings 192 and a Direct Connect (DC) fee setting 194. In this embodiment, the user's credit account 190 is the user's PayPal™ credit account.

Other contents may also be included in the user profile 180. In accordance with a privacy setting (described later), at least a portion of the user profile, e.g., Name, Title, Company, etc., is set as the user's public profile and is available to all users in the system 100 to read.

According to a method described in this disclosure, the system 100 allows each user to add other users (so called contact users) to their contact lists by paying a fee, and consequently establish connection to one or more contact users via their client computing devices to acquire help, assistance, consulting, advice or the like. The fee a first user paid for adding a second user to the contact list thereof comprises a basic fee payable to the service provider of the system 100, and a DC fee designated by the second user, which is split between the service provider of the system 100 and the second user based on an arrangement, typically a ratio agreed between the second user and the system 100 (described later).

Accordingly, the system 100 supports at least two types of contact lists for each user, i.e., a regular contact list and a DC contact list. A user's regular contact list includes contacts the user added thereto by paying the basic fee only (i.e., the contact user does not charge a DC fee). A user's DC contact list includes contacts the user added thereto by paying the basic fee and a DC fee (i.e., the contact user charges a non-zero DC fee).

As those skilled in the art appreciate, a person has to register in the computer network system 100 to become a user thereof and to use the service provided by the system 100. During or after registration, a user may set up his user profile and deposit funds in his credit account 190. Then, the user may build one or more contact lists 186 by adding other users thereto, and establish private connection to contact users in the contact lists 186.

As described above, the system 100 charges a basic fee to a user who initiates a request for adding another user to his contact list 186. Each user may also designate a fee for adding him to another user's contact list 186. When a first user has paid a fee from his credit account 190 to add a second user to his contact list 188, at least a portion of the fee paid is deposited to the system credit account 148, and the rest of the fee paid is deposited to the second user's credit account. Then, the first and second users may establish a private connection between their client computing devices 106, with the support and administration of the communication server 146.

FIG. 4 is a flowchart illustrating a process 220 for a user, e.g., User_A, to establish connections to other users. As shown, User_A first sets up his profile (step 222). Then, User_A may establish Direct Connection (DC) contacts with other users by adding other users to his contact lists (step 224). After establishing DC contacts, User_A may interact with users in his contact lists and review them (step 226).

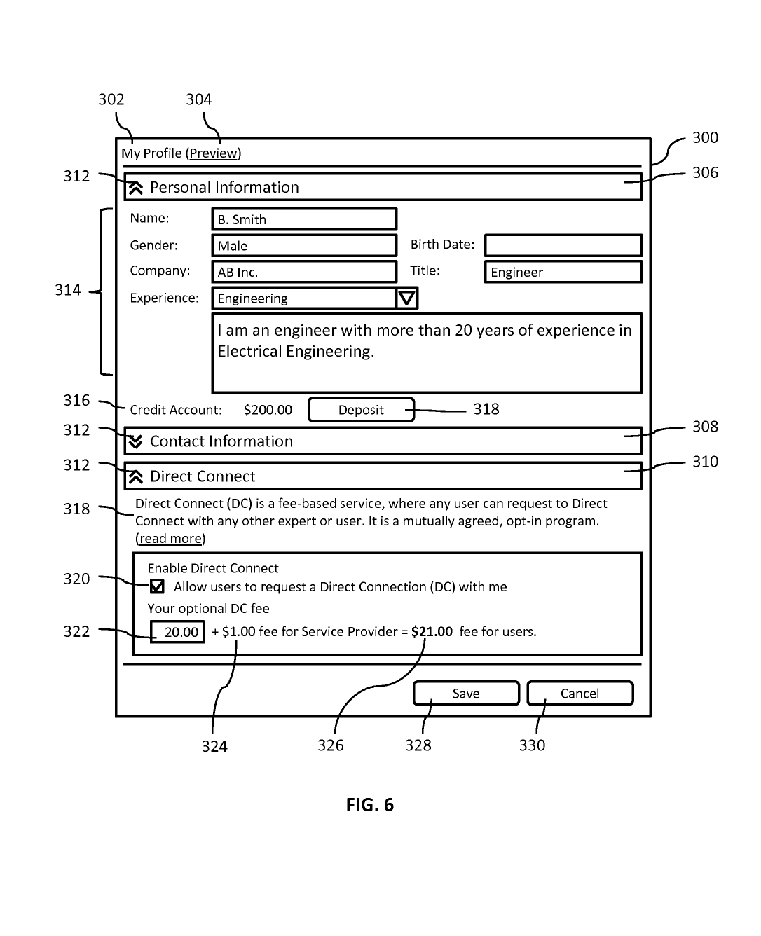

FIG. 5 illustrates the detail 260 of step 222 for User_A to set up his user profile. After User_A logs in to the computer network system 100, and launches a profile editing tool (see FIG. 6), User_A sets up his personal information, e.g., name, gender, birth date, company, title, experience and the like (step 262), and provides his contact information, e.g., phone numbers, email address, work address and the like (step 264). User_A may also set up his privacy settings (step 266) to indicate which of his information, which forms his public profile, may be viewed by other people free-of-charge. User_A may further sets up a DC fee that will be charged to users who add him to their contact lists (step 268).

FIG. 6 shows a portion of an example Graphic User Interface (GUI) 300 that User_A may use to set up his user profile. The GUI 300 comprises a GUI title 302, a link 304 for previewing the user profile, and a plurality of sections 306 to 310. The title of each section 306 to 310 comprises a button 312 for expanding or collapsing the content of the section. In the example shown in FIG. 6, the personal information section 306 and the direct connect section 310 are expanded, and the contact information section 308 is collapsed.

The personal information section 306 comprises a plurality of fields 314 for User_A to enter his personal information, e.g., name, gender, birth date, company, title, experience and the like. The personal information section 306 also displays the current balance 316 of User_A's credit account, and comprises a “Deposit” button 318 that User_A my click or tap to deposit more credits into his credit account.

The Direct Connect section 310 displays an explanation 318 of the Direct Connect service, and comprises a checkbox 320, which, if checked, indicates that User_A allows other users to request a DC contact with him, i.e., allowing other users to request for adding User_A to their contact lists. No user is allowed to request a DC contact with User_A if the checkbox 320 is unchecked. The Direct Connect section 310 also comprises a text field 322 for User_A to enter a DC fee, i.e., a user designated, non-negative credit amount that will be charged to users who request a DC with User_A.

In addition to the DC fee 322, the Direct Connect section 310 also displays the basic fee 324 and the total fee 326, which is the summation of the user designated DC fee 322 and the basic fee 324. In this example, the DC fee designated by User_A is $20.00, and the basic fee is $1.00, giving rise to a total fee of $21.00.

After filling in the fields in GUI 300, User_A may click or tap the “Save” button 328 to save the information he entered into GUI 300 into his profile, or, click or tap the “Cancel” button to discard the information he entered into GUI 300.

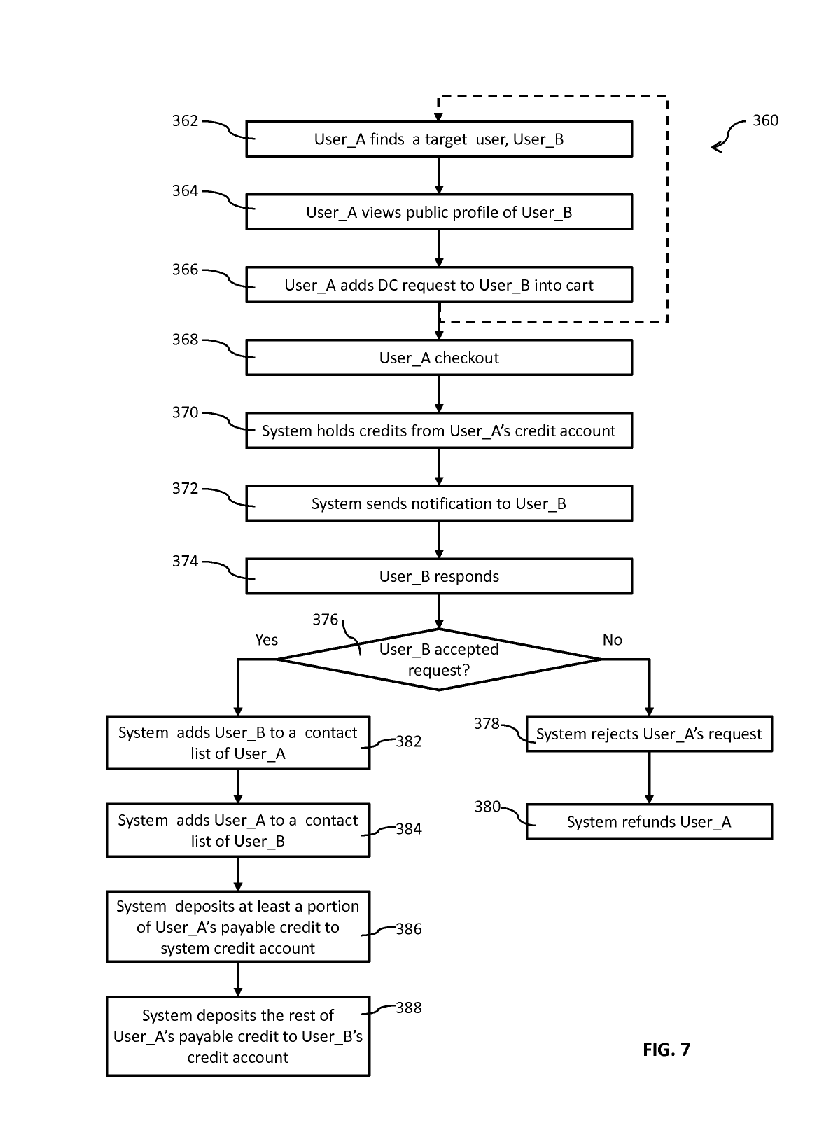

FIG. 7 illustrates the detail 360 of step 224 for User_A to establish a DC contact with another user. At step 362, User_A finds a target user, e.g., User_B, by means of searching in the system 100, browsing a user list of system 100 or the like (step 362). After finding User_B, User_A may view the public profile of Uer_B (step 364).

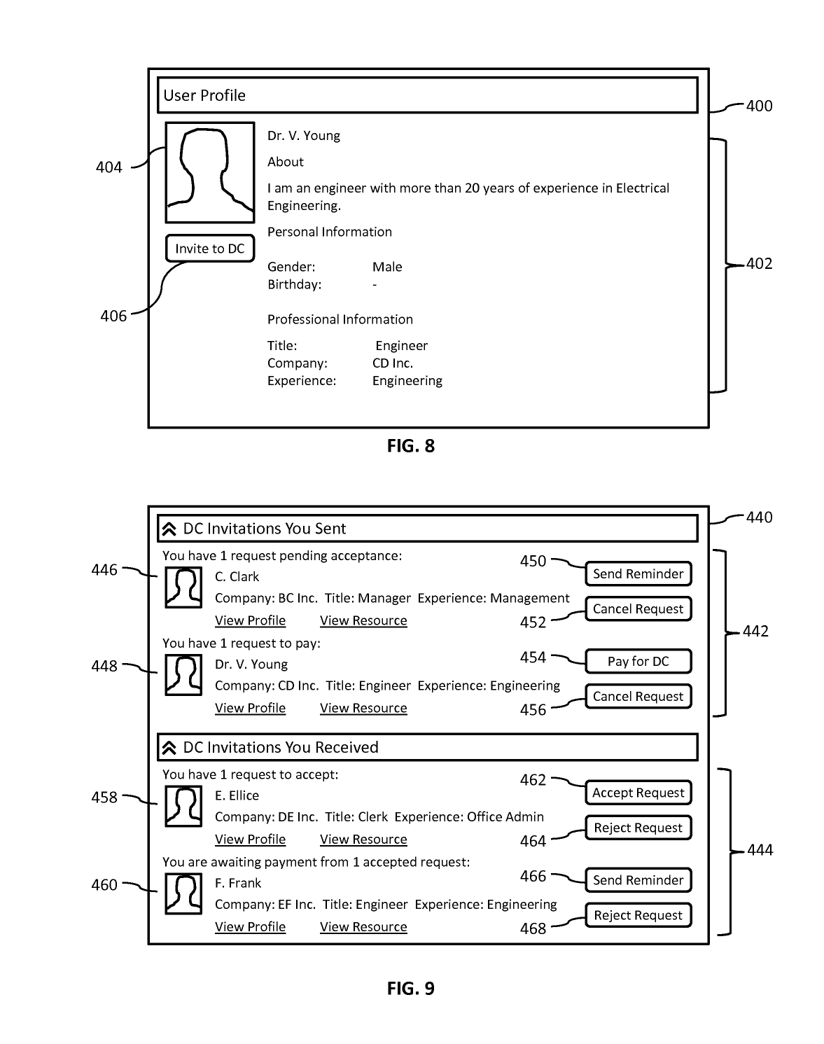

FIG. 8 shows a portion of an example GUI 400 displaying User_B's public profile, including basic information 402 and a picture 404. The GUI 400 also comprises an “Invite to DC” button 406. User_A may click the button 406 to put a DC contact request to User_B into a virtual shopping cart for requesting a DC contact therewith.

Referring back to FIG. 7, in the event User_A decides to establish a DC contact with User_B, User_A adds a DC contact request to User_B into a virtual shopping cart (step 366). User_A may repeat steps 362 to 366 (see the dashed line in FIG. 7) to find other users and add more DC contact request to his virtual shopping cart.

At step 368, User_A chooses to check out. Similar to the check-out procedure commonly seen in many online shopping websites, the system 100 leads User_A to go through a check-out procedure by asking User_A for his credit account information, or by using a credit account information previously provided by User_A and cached in the system, to facilitate User_A to pay credits for establishing DC contact with users he selected in steps 362 to 366.

After User_A completes the check-out procedure, the system holds the payable amount of credits from User_A's credit account (step 370), and sends a notification to the target users, e.g., User_B, that User_A chose to establish DC contact therewith (step 372). After receiving the notification, the target user, User_B, responds by replying the system with an acceptance or rejection (step 374).

FIG. 9 illustrates a portion of an example GUI 440 listing DC contact requests (so called DC invitations) that User_B has sent, and DC contact requests that User_B has received.

Section 442 of GUI 440 shows DC invitations that User_B has sent, including DC invitations 446 pending acceptance from target users, and DC invitations 448 having been accepted by the target users but pending payment from User_B. For each of the DC invitations 446 pending acceptance from target users, a “Send Reminder” button 450 and a “Cancel Request” button 452 are provided for sending a DC contact request reminder to the target user and for cancelling the DC contact request, respectively. For each of the DC invitations 448 having been accepted by the target users but pending payment from User_B, a “Pay for DC” button 454 and a “Cancel Request” button 456 are provided for paying credits from User_B's credit account for the DC contact request, and for cancelling the DC contact request, respectively.

Section 444 of GUI 440 shows DC invitations that User_B has received, including invitations 458 waiting for User_B to accept, and DC invitations 460 that User_B has accepted but still waiting for payment. For each of the DC invitations 458 waiting for User_B to accept, an “Accept Request” button 462 and a “Reject Request” button 464 are provided for accepting the DC contact request and for rejecting the DC contact request, respectively. For each of the DC invitations 460 that User_B has accepted but still waiting for payment, a “Sender Reminder” button 466 and a “Reject Request” button 468 are provided for sending a reminder to the respective user to remind him to pay for his DC contact request, and for rejecting the DC contact request, respectively.

Referring back to FIG. 7, after User_B replies User_A's request at step 374, the system checks User_B's response (step 376). If User_B replies with a rejection, the system then rejects user_A's DC contact request (step 378) and releases the payable credits held from User_A's credit account back thereto (step 380).

If User_B replies with an acceptance at step 376, the system then adds User_B to a contact list of User_A (step 382). In particular, User_B is added to User_A's regular contact list if User_B does not charge a DC fee, and is added to User_A's DC contact list if User_B charges a DC fee. When User_B is added to User_A's contact list, User_B's public profile and contact information, e.g., User_B's name, title, company, phone number and email address, are also automatically downloaded to User_A's client computing device 106.

The system also adds User_A to the regular contact list of User_B (step 384). Similarly, User_A's public profile and contact information, e.g., User_A's name, title, company, phone number and email address, are also automatically downloaded to User_B's client computing device 106. Then, the system transfers out of User_A's credit account the payable credits it holds therefrom, and deposits at least a portion of the payable credits to the system credit account (step 386), and deposits the rest of the payable credits to User_B's credit account (step 388). In this embodiment, the split of payable credits is determined as follows:

C_sys=(F_total−F_bas)*R_sys+F_bas,

C_user=(F_total−F_bas)*(1−R_sys),

where C_sys represents the credits payable to the system credit account, C_user represents the credits payable to User_B's credit account, F_total=F_user+F_bas represents the payable credits paid by User_A for adding User_B to his contact list, F_bas represents the basic fee, F_user represents the DC fee designated by User_B, and R_sys represents the percentage of the DC fee F_user that shall be payable to the service provider of the system 100. As those skilled in the art appreciate, R_sys and F_bas may be negotiated between the user and the service provider, and agreed by both parties when the user registers in the system 100.

As illustrated at step 226 in FIG. 4, after User_A establishes a DC contact with User_B, User_A may interact with User_B by setting up a private conversation connection between User_A's client computing device and User_B's client computing device via the network 102, and review User_B with comments and rating. Depending on User_A's choice, the conversation connection may be an audio, video or data connection, or a multimedia connection for transferring at least some of audio, video and data information.

Examples of an audio connection may be a phone call from User_A's smart phone to User_B's smart phone, or an audio conversation connection from an instant messaging program running on User_A's computing device (e.g., smart phone, tablet or computer) to that running on User_B's computing device.

Examples of a video connection may be a video phone call from User_A's smart phone to User_B's smart phone, or a video conversation connection from an instant messaging program running on User_A's computing device (e.g., smart phone, tablet or computer) to that running on User_B's computing device.

An example of a data connection may be a digital file transfer connection between User_A's computing device (e.g., smart phone, tablet or computer) and User_B's computing device.

An example of a multimedia connection may be a multimedia connection between an instant messaging program running on User_A's computing device (e.g., smart phone, tablet or computer) and that running on User_B's computing device, which User_A and User_B may use for verbal conversation, text conversation, video conversation and sending digital files.

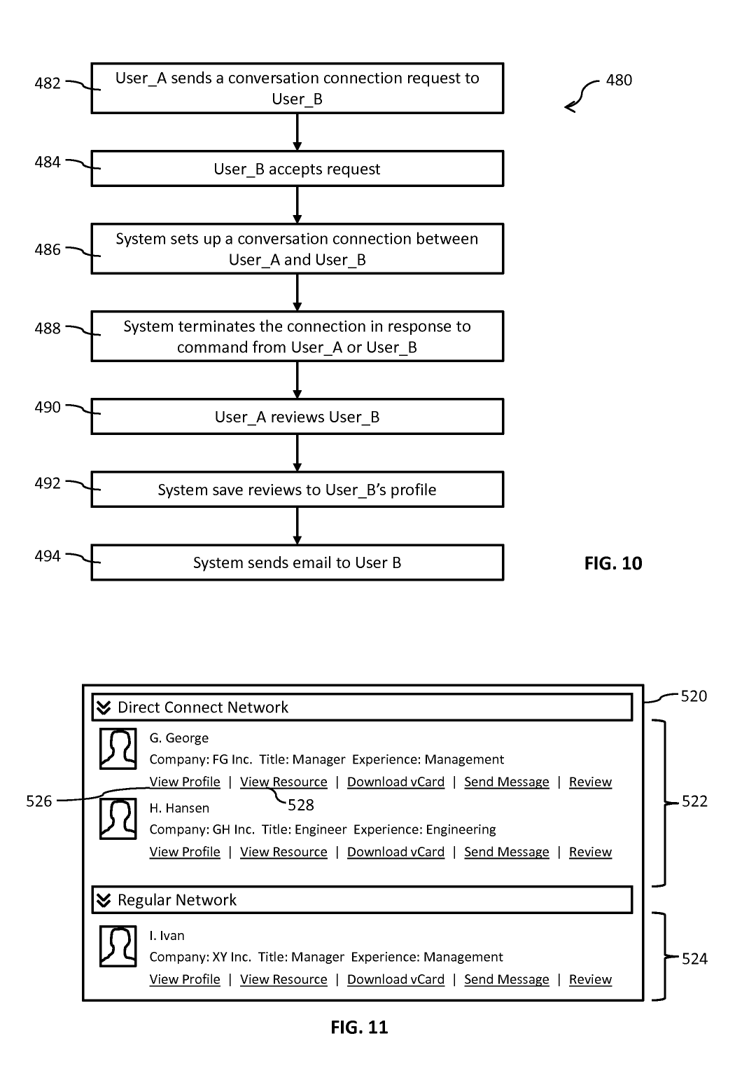

FIG. 10 shows an example 480 of the detail of step 226. At step 482, User_A sends a conversation connection request to User_B, requesting for setting up a conversation connection between their client computing devices. After User_B accepts the request (step 484), the system 100 sets up a conversation connection between User_A's client computing device and User_B's client computing device (step 486). User_A and User_B may use this conversation connection to exchange audio, video and data information, e.g., audio/video chatting, sharing the screen images of their computing devices, sending files or the like. After they finish interaction, either User_A or User_B may send a terminate-connection command to the system, and the system terminates the conversation connection between their client computing devices accordingly (step 488). User_A may review User_B by recording his comments and rating regarding User_B using a review tool (not shown) provided by the system 100. The system 100 saves User_A's review to User_B's profile (step 492) as a portion of his public profile so that it is available for all users in the system to read. The system 100 then sends User_B a notification, which is an email in this embodiment, notifying User_B that User_A has reviewed him (step 494).

Similarly, User_B may also request for setting up a conversation connection to User_A. User_B may also review User_A.

The system 100 provides a GUI for each user to browse his own contact lists. FIG. 11 shows an example of the GUI 520. As shown, the GUI 520 displays each contact list in a separate section. For example, each contact user in the DC contact list is displayed as a contact record in a Direct Connect Network section 522, and each contact user in the regular contact list is displayed as a contact record in a Regular Network section 524. Each contact record shows brief information (e.g., name, company and title) of the contact user, and includes a plurality of link for the user to perform further actions. For example, a “View Profile” link 526, if clicked, allows the user to review the profile of the contact user; a “View Resource” link 528, if clicked, allows the user to view resources associated with the contact user such as files that the contact user attached to his profile; a “Download vCard” link 530, if clicked, allows the user to download the contact user's contact information, including phone numbers and address, in the vCard format (e.g., a VCF file). Then download vCard file may be loaded directly into an e-mail program, such as Microsoft® Outlook® or into a customer relationship management (CRM) system.

The system disclosed herein provides a platform for users to profit from being connected with other users. For example, a senior engineer, Angela, may register into system 100, and highlight her 25 years of oil and gas industry experience in her public profile. After registering into the system, the system 100 provide Angela a plurality of means, e.g., blogs, online publications, podcast and the like, to post content beneficial to other users. Other users may view her posted content free-of-charge. However, as her public profile does not contain her contact information, Angela is protected from being flooded with connection requests from random users. On the other hand, Angela may designate a $20 DC fee for charging users who want to connect with her. In this example, Angela has agreed with the service provider of the system 100 a 75%:25% split ratio for splitting the DC fee therebetween, i.e., the system provider takes R_sys=25% of the DC fee other users paid to her. In addition to the DC fee, the system 100 also charges each user seeking to connect with other users a $1 basic fee payable to the service provider of the system 100.

As described above, other users may benefit from the content Angela's posted in the system 100. If a junior engineer, Gerry, wishes to obtain further help from Angela, he may request for a DC connection by paying a total of $21, which is the summation of the $20 DC fee and the $1 basic fee.

Following above-mentioned process, after Angela agrees to be added to Gerry's DC contact list, the system 100 transfers $21 from Gerry's credit account. The system 100 then deposits $6 (=$20×25%+$1) to the system credit account, and deposits $15 (=$20×75%) to Angela's credit account.

After adding Angela to his DC contact list, Gerry may establish a private connection between his client computing device and Angela's client computing device to, e.g., establish a dialogue with Angela for obtaining further help and advice.

In an alternative embodiment, the system 100 provides functionalities to flag both the requester, i.e., the user who requests for a DC connection with an expert, and the expert who receives the request to rate/review each other, the ratings becoming part of both the requester's and the expert's profile saved in their personal ratings. As described above, the system 100 also provides functionalities to exchange electronic business cards, generally contact information in a VCF or other suitable format, which can be imported into email or CRM applications. The system 100 further provides functionalities to incorporate both the requester's and the expert's contact information into their respective professional network lists contained in their individual social network profiles with additional information being available to direct connect users therethrough.

In yet another embodiment, the mutual user rating further provides a Risk Management-Quality Assurance (QA) feature. With the mutual peer user rating model, the requester and the expert rate each other in order to provide a degree of quality assurance for other users. Such a reciprocal approach has proven to be effective and self-correcting as the mutual ratings motivate users to be reasonable in dealing with each other so as not to damage their reputations and credibility for future transactions.

In still another embodiment, the expert/requester feedback rating and review is done in one simple form, which may include rating categories such as overall rating with rating options of one (1) to five (5) stars where one stare means worst and five stars means best, rating on speed of response with rating options of one (1) to five (5) stars, rating on quality of interaction with rating options of one (1) to five (5) stars, rating on value with rating options of one (1) to five (5) stars. The feedback rating and review may also include a comments field for reviewer to enter comments.

Other embodiments are also available. In an alternative embodiment, the system further allows a user to purchase service time from a contact user in his contact list. In this embodiment, a user's profile further comprises a field of service time rate, e.g., an hourly service rate, that the user sets up.

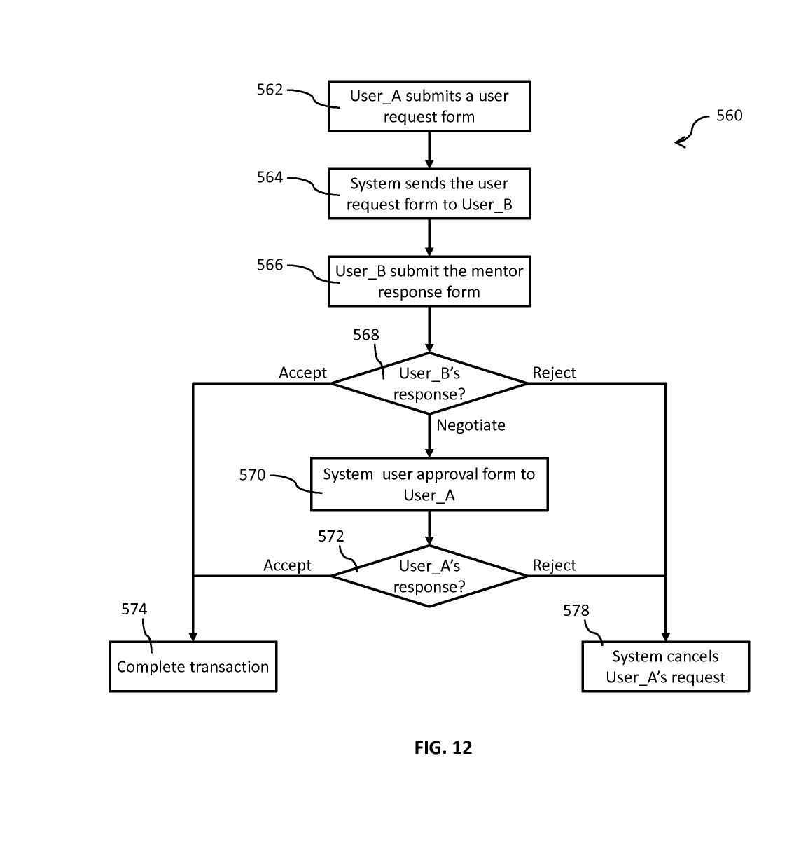

FIG. 12 illustrates a process 560 for a user, e.g., User_A, to purchase service time from another user, e.g., User_B. At step 562, User_A fills in and submits a user request form using a GUI provided by the system.

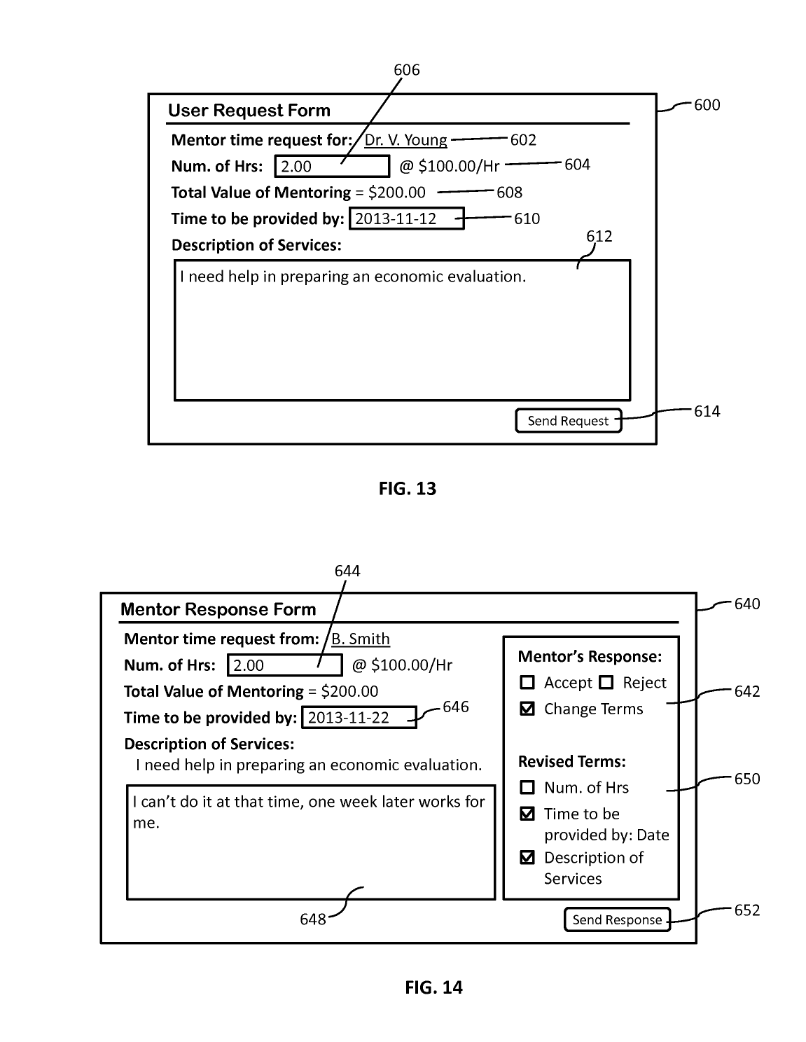

FIG. 13 shows an example of the purchase request form GUI 600. As shown, the GUI 600 comprises User_B's name 602, an hourly rate that User_B has set. User_A fills in the number of hours 606 he wants to purchase for service, and the system automatically calculates the credits required for the purchase and displays it in the total value field 608. User_A also selects a date and time 610 that the service shall be provided, and enters a description of services 612. User_A submits the user request form 600 by clicking the “Send Request” button 614.

Referring back to FIG. 12, after User_A submits the user request form, the system sends the form to User_B (step 564). User_B receives the user request form and in response, submits a mentor response form (step 566), in which User_B indicates his response to the request.

FIG. 14 shows an example of the mentor response form GUI 640. As shown, the GUI 640 comprises the information submitted from User_A. User_B may select a response “accept”, “reject” or “change terms” in the response zone 642. If User_B selects “change terms”, he may modify the number of hours 644, service date and time 646, and enter the reason of modification 648. The system automatically detects User_B's modification and indicates the revised items in the revised term zone 650. User_B submits the mentor response form 640 by clicking the “Send Response” button 652.

Referring back to FIG. 12, after User_B submits the mentor response form, the system checks User_B's response (step 568). If User_B accepts the request, User_A and User_B complete the purchase transaction with the assistance of the system (step 574). If User_B has changed terms to negotiate, the system prepares a user approval form in accordance with the mentor response form it received from User_B and sends the user approval form to User_A for approval (step 570).

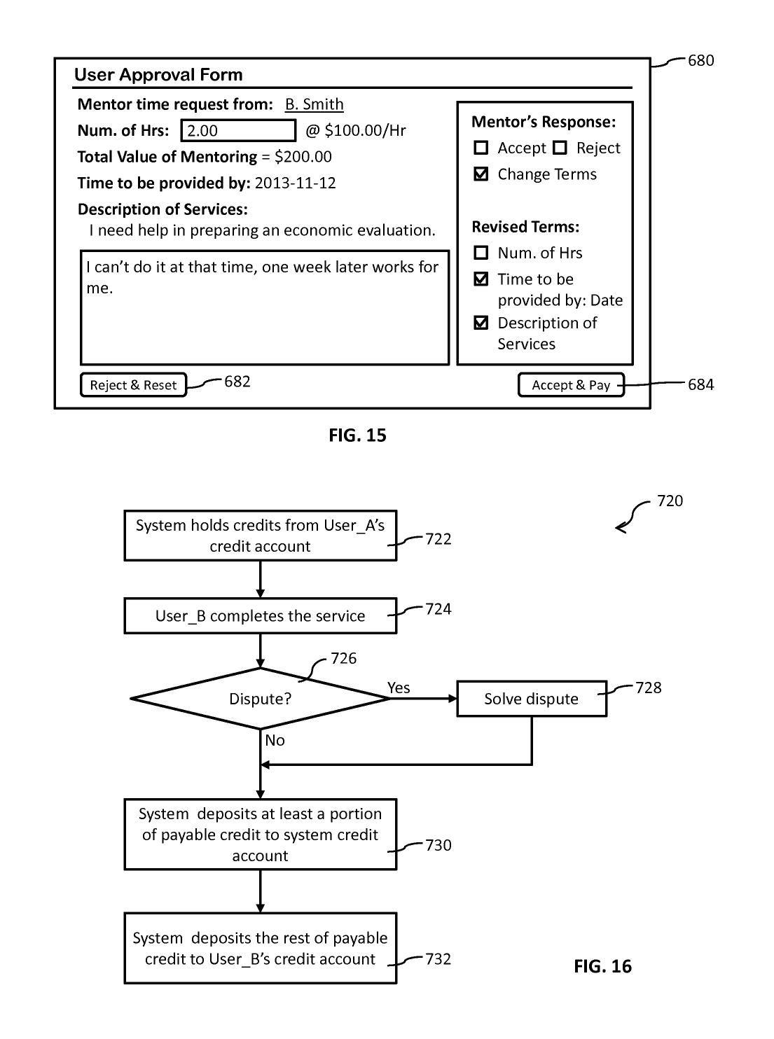

FIG. 15 shows an example of the user approval form GUI 680. As shown, the user approval form 680 is generally the same as the mentor response form 640. User_A may click the “Reject & Reset” button to reject User_B's terms and cancel the purchase request, or click “Accpet & Pay” button 584 to accept User_B's terms and pay the payable credits for completing the service time purchasing.

Referring back to FIG. 12, the system checks User_A's response (step 572). If User_A accepts User_B's terms, User_A and User_B complete the purchase transaction with the assistance of the system (step 574). If User_A rejects User_B's terms, the system cancels User_A's purchase request (step 578).

If, at step 568, User_B rejects User_A's purchase request, the system cancels User_A's purchase request (step 578).

FIG. 16 illustrates the detail 720 of the completing transaction step 574 in FIG. 12. At step 722, the system 100 holds the credits agreed in the aforementioned negotiation between User_A and User_B from User_A's credit account for purchasing User_B's service time. User_B then works with User_A to complete the service (step 724). After User_B or User_A sends a service-complete message to the system 100, e.g., via a GUI provided by the system (not shown), the system checks if there is any dispute between User_A and User_B (step 726). Here, User_A or User_B may submit a dispute to the system via a GUI (not shown). If there is not dispute, the process goes to step 730.

If there is a dispute between User_A and User_B, the service provider of the system assists User_A and User_B to solve the dispute and arrive at a solution with an agreed payable credits (step 728), which maybe the full amount of the originally agreed credits, a portion of the originally agreed credits or zero credit.

At step 730, the system transfers out of User_A's credit account the agreed payable credits from the credits it holds therefrom, refunds the balance, if any, to User_A's credit account, and deposits at least a portion of agreed payable credits to the system credit account. The system then deposits the rest of payable credits to User_B's credit account (step 732).

In this embodiment, the system splits User_A's payable credits for purchasing service time between the system and User_B in accordance with a ratio mutually agreed between the system and User_B when, e.g., User_B registered as a user of the system. The calculation is as follows:

D_sys=D_pay*P_sys,

D_user=D_pay*(1−P_sys),

where D_sys represents the credits payable to the system credit account, D_user represents the credits payable to User_B's credit account, D_pay represents the payable credits agreed between User_A and User_B for purchasing User_B's service time, and P_sys is the percentage of D_pay that shall be payable to the service provider of the system 100.

The system in this embodiment thus establishes a multiple-level fee structure for a user to profit from being connected with other users and from providing services (e.g., mentoring) thereto.

For example, a senior engineer, Angela, may designate a $20 DC fee and a $250/hour service fee for providing mentoring to other users via private connections between the client computing devices thereof. Angela may further designate a consulting fee for professional services to be provided offline. Upon agreement with Angela, the system may establish a multiple-level fee structure such that the DC fee is split between Angela and the service provider of the system 100 in accordance with a 75%:25% scheme, the service fee is split between Angela and the service provider of the system 100 in accordance with a 90%:10% scheme, and the system does not take any portion of the consulting fee for professional services provided offline.

As described above, a junior engineer, Gerry, may pay $21 for adding Angela to his DC contact list, of which $15 are paid to Angela's credit account, and $6 are paid to the system credit account. Gerry may further purchase a two (2) hour mentoring service from Angela following the method described in FIGS. 12 to 16 and paying $500 in total, of which $50 are paid to the system credit account, and $450 are paid to Angela's credit account.

During the course of mentoring, Gerry may obtain clear understanding of Angela's professional expertise, and find that her expertise best matches a project that Gerry will start. Then, Gerry may contract Angela to complete the project offline for terms to be negotiated, such as a lump sum of $2000. According to the agreement between Angela and the system, the system 100 does not take any portion of the $2000 paid from Gerry to Angela.

Although in the embodiment in FIG. 12, User_A has to decide whether or not to accept or reject User_B's terms, in an alternative embodiment, the system allow User_A further modifies User_B's terms. A plurality rounds of negotiation is therefore allowed before User_A and User_B reach an purchase agreement or the purchase request is cancelled.

Although in above embodiments, the system 100 is engaged with the PayPal™ and uses PayPal™ credit accounts as the credit accounts of users and the service provider of system 100, in some other embodiments, the system 100 may alternatively use other credit accounts such as credit card accounts, bank accounts, credit or points accounts of stores or loyalty programs recognized by the system 100 (e.g., Aeroplan® Loyalty Program, AIR MILES® Reward Program, Petro-Points™, Canadian Tire ‘Money’ Advantage™ program, or the like) or a combination thereof, depending on the implementation of system 100.

In another embodiment, the system provides functionalities for users to associate with other social networks such as LinkedIn®, Facebook®, Twitter® and Google+™ such that users may promote their resources stored in the system 100 to their accounts in other social networks with one click.

What is claimed is:

1. A method for establishing a conversation connection between a first and a second client computing devices via a computer network, said method comprising:
setting up a system credit account;
registering the user of the first client computing device in the computer network, said registering comprising registering a first credit account for the user of the first client computing device;
registering the user of the second client computing device in the computer network, said registering comprising registering a second credit account for the user of the second client computing device;
in response to a first command from the user of the first client computing device, transferring a request for establishing contact from the user of the first client computing device to the user of the second client computing device,
in response to a second command of the user of the second client computing device, establishing a contact between the user of the first client computing device and the user of the second client computing device; and
in response to a third command from any one of the user of the first client computing device and the user of the second client computing device, establishing a conversation connection between the first and second client computing devices; wherein said establishing a contact further comprises:
transferring a total amount of credits out of the first credit account;
depositing at least a portion of the total amount of credits into the system credit account; and
depositing the rest of the total amount of credits into the second credit account.

2. A method of claim 1 wherein said total amount of credits comprises a total of a first amount of credits and a basic amount of credits.

3. A method of claim 2 further comprising:
setting up the first amount of credits, in response to a fourth command from the user of the second client computing device.
